(19) United States
(12) Patent Application Publication
(10) Pub. No.: US 2026/0012964 A1
(43) Pub. Date: Jan. 8, 2026

(54) TIME DIVISION MULTIPLEXING BROADCASTING METHOD FOR WIRELESS COMMUNICATION SYSTEM AND COMMUNICATION DEVICE

(71) Applicant: OPEN ROAD SOLUTIONS, INC., Hsinchu City (TW)

(72) Inventors: CHING-TSAI CHOU, Hsinchu City (TW); CHENG-YI WANG, Hsinchu City (TW)

(73) Assignee: OPEN ROAD SOLUTIONS, INC., Hsinchu City (TW)

(21) Appl. No.: 18/764,917

(22) Filed: Jul. 5, 2024

(51) Int. Cl. H04W 72/30; H04W 4/06; H04W 72/0446

(52) U.S. Cl. CPC H04W 72/30; H04W 4/06; H04W 72/0446

(57) ABSTRACT

A TDMB method for wireless communication system with multiple devices is provided, wherein each period of time is divided into multiple voice frames, each voice frame includes multiple voice slots, and each voice slot is divided into multiple subslots for transmitting or relaying voice packets, including: a first device receives a first voice message from a second device in a first subslot of a first voice slot in a voice frame; and the first device broadcasts a second voice message, including the voice packet, in a second subslot of a second voice slot in the voice frame if the first voice slot is not the last voice slot in the voice frame, wherein the second voice slot is a voice slot following the first voice slot, and the second subslot in the second voice slot is located at the same place as the first subslot in the first voice slot.

### FIELD OF THE INVENTION

The present invention relates generally to a wireless broadcasting method, and more particularly, to a time division multiplexing broadcasting (TDMB) method for wireless communication system.

### BACKGROUND OF THE INVENTION

Wireless communication has long been a preferred choice of communication since its inception. However, it is only until the last few decades, the wireless communication has been fully explored and utilized to actually application due to the advance of related enabling technologies. More specifically, each new generation of wireless communications creates more sophisticated capabilities to allow users more flexibility. As a result, users can now connect to resources from anywhere, and mobile devices have become more powerful and versatile, giving users the opportunity to complete complex tasks.

Wireless communication relies on broadcasting for transmission of information, such as audio, video, or data, and is widely used in various applications, including radio and television broadcasting, Wi-Fi, Bluetooth, cellular networks, and many more. Unlike the conventional one-to-one or one-to-many broadcasting systems where the contents are transmitted to a specific receiver or a dispersed audience via any electronic mass communications medium, but typically one using the electromagnetic spectrum (radio waves), the modern wireless communication systems are many-to- many broadcasting models. To enable a scenario including multiple transmitters and receivers, a multiplexing technique by which multiple data signals can be transmitted over a common communication channel in different time slots is devised and known as Time Division Multiplexing (TDM). The time division multiplexing broadcasting (TDMB) allows the division of the overall time domain into various fixed length time slots. By TDM definition, a single frame is said to be transmitted when it's all signal components get transmitted over the channel.

There are numerous TDMB-based applications. One of the most prominent exemplars for the emerging popular application is the usage of Bluetooth headsets for outdoor activities, such as motorcycle ridings. Many motorcycle enthusiasts go on group ridings. However, differences in individual speed and road conditions can lead to incremental distances between group members. Therefore, the audio real-time communication between individuals becomes necessary for the group members to share and coordinate various information, such as, real-time road conditions, emergencies, or sudden changes in planned routes.

However, for the aforementioned Bluetooth motorcycle headsets, due to the limited communication range and lack of sufficient bandwidth, a pressing shortcoming remains to be solved is how to accommodate a large number of group members over a large coverage distance and area.

It is therefore imperative to devise a smart TDMB protocol to address these issues to make wireless communication devices more convenient and reliable.

### SUMMARY OF THE INVENTION

A primary objective of the present invention is to provide a time division multiplexing broadcasting (TDMB) method for wireless communication system, able to accommodate a large group of users over a large coverage distance and area.

Another objective of the present invention is to provide a TDMB method for wireless communication system, utilizing simple data structure to effectively improve the bandwidth utilization of the wireless communication system.

To achieve the aforementioned objective, the present invention provides a TDMB method for wireless communication system, wherein there are multiple devices in a group, each period of time in the wireless communication system is divided into multiple voice frames, each voice frame includes multiple voice slots, and each voice slot is divided into multiple subslots which are used for transmitting or relaying voice packets, the TDMB method comprising: a first device receives a first voice message from a second device in a first subslot of a first voice slot in a voice frame, wherein the first voice message includes a voice packet and first assignment information and the first assignment information indicates the first device; and the first device broadcasts or transmits a second voice message, including the voice packet, in a second subslot of a second voice slot in the voice frame if the first voice slot is not the last voice slot in the voice frame, wherein the second voice slot is a voice slot following the first voice slot, and the second subslot in the second voice slot is located at the same place as the first subslot in the first voice slot.

In a preferred embodiment, each subslot in the initial voice slot of each voice frame is used for initial transmission of one voice packet and subslots in the rest voice slots of each voice frame are used for relaying voice packets transmitted in the initial voice slot.

In a preferred embodiment, the second voice message further includes second assignment information which indicates a third device for transmitting or relaying the voice packet.

In a preferred embodiment, the first device does not broadcast or transmit the second voice message if the first assignment information does not indicate the first device. In another preferred embodiment, the first device does not broadcast or transmit the second voice message either if the first voice slot is the last voice slot in the voice frame.

In a preferred embodiment, each voice frame further includes at least a beacon.

In a preferred embodiment, the first voice message further includes a group identity (ID) of the group.

In a preferred embodiment, the first voice message further includes a number of the first voice slot.

The present invention also provides a communication device, comprising: a control circuit; a processor installed in the control circuit; a memory installed in the control circuit and coupled to the processor; wherein the processor is configured to execute a program code stored in the memory to perform the aforementioned TDMB method steps.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a schematic view of a wireless communication system applicable for the present invention.

FIG. 2 shows a schematic view of the frame structure for the TDMB

method according to the present invention.

FIG. 3 shows a flowchart of the TDMB method for wireless communication system according to the present invention.

FIG. 4 shows a schematic view of an exemplary group of seven devices based on the TDMB method of the present invention.

FIG. 5 shows a timeline diagram of the voice slots and operations of the devices in FIG. 4.

### DETAILED DESCRIPTION OF THE INVENTION

The accompanying drawings are included to provide a further understanding of the invention, and are incorporated in and constitute a part of this specification. The drawings illustrate embodiments of the invention and, together with the description, serve to explain the principles of the invention. The terminology used herein is for the purpose of describing particular embodiments only and is not intended to limit the present invention. As used herein, the term “and/or” includes any and all combinations of one or more of the associated listed items.

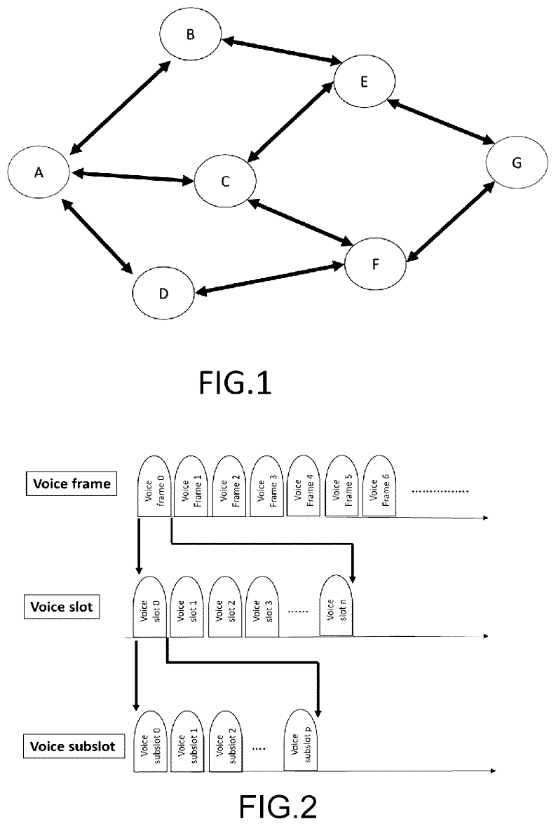

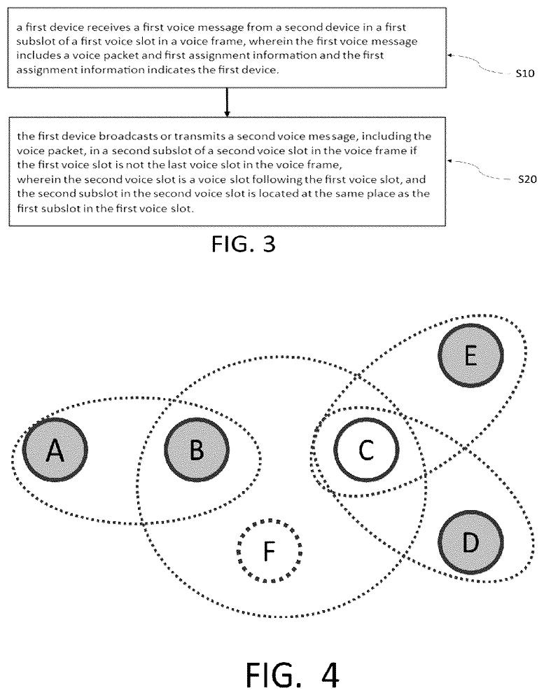

FIG. 1 shows a schematic view of a wireless communication system applicable for the present invention. FIG. 2 shows a schematic view of the frame structure for the TBMD method according to the present invention. FIG. 3 shows a flowchart of the TDMB method for wireless communication system according to the present invention.

As shown in FIG. 1 the applicable wireless communication system includes a plurality of devices forming a group, and the devices are labelled as A, B, . . . , G, respectively. As shown in FIG. 2, the present invention defines the following frame structure, wherein each period of time in the wireless communication system is divided into multiple voice frames, each voice frame includes multiple voice slots, and each voice slot is divided into multiple subslots which are used for transmitting or relaying voice packets.

The present invention also defines a speaking-right. A device in a group can obtain the speaking-right through a specific mechanism. A device with the speaking-right can speak using a particular voice subslot within one of the initial voice slots of a voice frame. Other group devices then relay the voice message received from that device using the voice subslot at the same position within subsequent voice slots in the same voice frame. The possession of the speaking-right will be released by a device and made available for other group devices to use when certain conditions are met, such as when the device does not speak for a certain period.

Accordingly, three types of devices within the coverage area of the wireless communication system are defined: non-group-device, group device without speaking-right, and group device with speaking right. It should be noted that the non-group-device can do nothing but receiving voice messages, i.e., it can only listen to the conversation between group devices. A group device is defined as a device belonging to a specific group of devices. Typically, a device can choose to join a certain group or not. Once a device joins a group through a specific mechanism, it can obtain the speaking-right and take on the role of message relay. Also, when a device can directly receive messages from another device and vice versa, the two devices are defined as within each other's device coverage. For two devices not within each other's coverage, messages may be relayed to each other through a third group device.

As shown in FIG. 3, the TDMB method for wireless communication system of the present invention includes the following steps:

In step S10, a first device receives a first voice message from a second device in a first subslot of a first voice slot in a voice frame.

It should be noted that the first voice message includes a voice packet and first assignment information and the first assignment information indicates the first device.

In step S20, the first device broadcasts or transmits a second voice message, including the voice packet, in a second subslot of a second voice slot in the voice frame if the first voice slot is not the last voice slot in the voice frame.

Specifically, the second voice slot is a voice slot following the first voice slot, and the second subslot in the second voice slot is located at the same place as the first subslot in the first voice slot.

More specifically, each subslot in the initial voice slot of each voice frame is used for initial transmission of one voice packet and subslots in the rest voice slots of each voice frame are used for relaying voice packets transmitted in the initial voice slot.

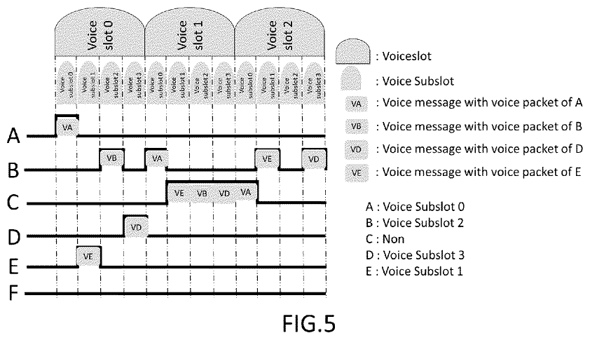

FIG. 4 shows a schematic view of an exemplary group of seven devices based on the TDMB method of the present invention. As shown in FIG. 4, the devices of the group are labeled as A, B, C, D, E, and F, respectively, wherein devices A-E are group devices, devices A, B, D, and E have obtained the speaking-right, while device C have not, and device F has not joined the group.

FIG. 5 shows a timeline diagram of the voice slots and operations of the devices in FIG. 4. As the scenario shown in FIG. 5, a voice frame includes three voice slots and each voice slot includes four voice subslots, wherein VA, VB, VD, and VE represent the voice message including a voice packet from the devices A, B, D, and E, respectively. Moreover, the device A is allocated with voice subslot 0, the device B is allocated with voice subslot 2, the device D is allocated with voice subslot 3, and the device E is allocated with voice subslot 1. As device C has no speaking-rights, no voice subslot is allocated.

As aforementioned, the TDMB method of the present invention follows the rules below:

If a device is the original speaker, the voice message transmission occurs within a first slot (i.e., voice slot 0) during its own voice subslot timing. That is, as in the scenario, VA, VB, VD, and VE are transmitted during the voice subslot 0, 2, 3, 1 in series. Moreover, the next device(s) to forward the voice packet in the voice message, which could involve multiple devices, are also included in the assignment information. It is worth noting that a device receiving the voice message but not included in the assignment information does not forward the voice packet in the voice message.

For voice message relaying, as there are three voice slots in a voice frame, if the voice packet in the voice message is being relayed for the first time, the relaying device transmits the relayed voice message in the original speaker's subslot within the second voice slot (i.e., voice slot 1). If relayed for the second time, the transmission occurs in the original speaker's subslot the third voice slot (i.e., voice slot 2). Again, the relaying device still includes the next device(s) to forward to, i.e., the assignment information. Therefore, in a preferred embodiment of the present invention, the second voice message further includes second assignment information which indicates a third device for transmitting or relaying the voice packet.

Therefore, as seen in FIG. 5, VA is relayed in voice subslot 0 of voice slot 1 and voice subslot 0 of voice slot 2. Similarly, VB is relayed in voice subslot 2 of voice slot 1, VD is relayed in voice subslot 3 of voice slot 1 and again in voice subslot 3 of voice slot 2, and VE is relayed in voice subslot 1 of voice slot 1 and again in voice subslot 1 of voice slot 2.

When a device is assigned to relay a voice message, the device first checks if the voice packet in the voice message has already been forwarded twice as there are three voice slots in a voice frame. If it has, the forwarding process stops. Hence, in a preferred embodiment of the present invention, the first device does not broadcast or transmit any voice message if the first voice slot is the last voice slot in the voice frame.

It is worth noting that the waveform in FIG. 5 indicates the operation of each device. There are two signal levels (i.e. high level and low level) in the timelines of devices. The high level indicates that is a transmission, and the low level indicates receiving a voice message. For example, the high level at the first voice subslot indicates device A is transmitting a voice message, while low levels at the first voice subslot indicate other devices are receiving voice messages. As the scenario shown in FIG. 5, the device A only transmit in voice slot 0, and no relaying is executed. The device B transmits in voice slot 0, relays VA in voice slot 1, and relays VE and VD in voice slot 2. The device C relays VE, VB, VD in voice slot 1, and relays VA in voice slot 2. The device D only transmits in voice slot 1, and the device E also only transmits in voice slot 1 without relaying.

Additional data and/or information can be included in the voice frame or voice message. For example, each voice frame further includes at least a beacon. The first voice message further includes a group identity (ID) of the group, or the first voice message further includes a number of the first voice slot.

The present invention also provides a communication device, comprising: a control circuit; a processor installed in the control circuit; a memory installed in the control circuit and coupled to the processor; wherein the processor is configured to execute a program code stored in the memory to perform the aforementioned TDMB method steps.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for Time Division Multiplex Broadcasting in a wireless communication system, wherein there are multiple devices in a group,
each period of time in the wireless communication system is divided into multiple voice frames,
each voice frame includes multiple voice slots,
each voice slot is divided into multiple subslots which are used for transmitting or relaying voice packets,
comprising:
a first device receives a first voice message from a second device in a first subslot of a first voice slot in a voice frame, wherein the first voice message includes a voice packet and a first assignment information and the first assignment information indicates the first device; and
the first device broadcasts or transmits a second voice message, including the voice packet, in a second subslot of a second voice slot in the voice frame if the first voice slot is not the last voice slot in the voice frame,
wherein the second voice slot is a voice slot following the first voice slot, and
the second subslot in the second voice slot is located at the same place as the first subslot in the first voice slot.

2. The method of claim 1, wherein each subslot in an initial voice slot of each voice frame is used for initial transmission of one voice packet and subslots in the rest voice slots of each voice frame are used for relaying voice packets transmitted in the initial voice slot.

3. The method of claim 1, wherein the second voice message further includes a second assignment information which indicates a third device for transmitting or relaying the voice packet.

4. The method of claim 1, wherein the first device does not broadcast or transmit the second voice message if the first assignment information does not indicate the first device or if the first voice slot is the last voice slot in the voice frame.

5. The method of claim 1, wherein each voice frame further includes at least a beacon.

6. The method of claim 1, wherein the first voice message further includes a group identity (ID) of the group.

7. The method of claim 1, wherein the first voice message further includes a number of the first voice slot.

8. A communication device, comprising:
a control circuit;
a processor installed in the control circuit;
a memory installed in the control circuit and coupled to the processor;
wherein the processor is configured to execute a program code stored in the memory to perform the method steps as defined in claim 1.
